(19) United States
(12) Patent Application Publication
(10) Pub. No.: US 2018/0262488 A1
(43) Pub. Date: Sep. 13, 2018

(54) METHOD AND SYSTEM FOR PROVIDING SECURE COMMUNICATION

(71) Applicant: I.X Innovation Co., Ltd., Apia (WS)

(72) Inventors: Yung-Chao TSENG, New Taipei City (TW); Tsu-Chin WU, Taipei City (TW); Chih-Ling CHIEN, New Taipei City (TW)

(21) Appl. No.: 15/917,506

(22) Filed: Mar. 9, 2018

Related U.S. Application Data
(60) Provisional application No. 62/470,445, filed on Mar. 13, 2017.

(51) Int. Cl. H04L 29/06; H04L 9/08; H04L 9/32

(52) U.S. Cl. CPC H04L 63/0853; H04L 63/0492; H04L 63/0478; H04L 9/0877; G06F 21/35; H04L 9/0863; H04L 9/3228; H04L 63/0442; H04L 9/3234

(57) ABSTRACT

A method for providing secure communication is provided. The method is used in a system including at least an electronic device and a card device. The method includes encrypting data transmitted to or decrypting data received from a second electronic device based on a first private key which is stored in the card device and is associated with the electronic device over a wireless connection between the electronic device and the card device, wherein the wireless connection is established when the card device is detected as being in proximity to the electronic device.

### CROSS REFERENCE TO RELATED APPLICATIONS

This application claims priority of U.S. Provisional Patent Application No. 62/470,445, filed on Mar. 13, 2017, the entirety of which is incorporated by reference herein.

### BACKGROUND OF THE INVENTION

### Field of the Invention

The disclosure relates generally to the field of computer systems. More particularly, the present disclosure relates to a method and a system for providing secure communication.

### Description of the Related Art

In the computing industry, it is of utmost importance for sensitive information to be secured properly. Today, there are various techniques for securing such information. One commonly used technique involves encrypting the data so that the data can only be decrypted (and thus used) by the intended individual or service. Encryption algorithms (e.g., AES, 3DES, and RC2) typically use an encryption key during the encryption and/or decryption process. In order to maintain the security of the encrypted data, however, the encryption key must be kept secret because, should the encryption key become compromised, the security of the encrypted data would be jeopardized. Thus, the security of the data relies upon proper protection of the encryption keys.

Computer users today are often faced with the challenge of creating and managing passwords for a number of user accounts (e.g., online accounts). The use of long random passwords offers some protection for their accounts, but the typical user remains prone to using weaker passwords (e.g., sequences of letters and numbers) because such passwords are easier for the user to remember. However, weak passwords can significantly lessen the security of a computer system because, for example, they can be prone to dictionary attacks.

Therefore, a method and a system for providing secure communication are needed to solve the problems described above.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method and a system for providing secure communication are provided.

In a preferred embodiment, a method for providing secure communication is provided in the disclosure. The method comprises: encrypting data transmitted to or decrypting encrypted data received from a second electronic device based on a first private key which is stored in the card device and is associated with the electronic device over a wireless connection between the electronic device and the card device; wherein the wireless connection is established when the card device is detected as being in proximity to the electronic device.

In a preferred embodiment, a system for providing secure communication is provided in the disclosure. The system at least comprises an electronic device and a card device storing a first private key associated with the electronic device. The electronic device encrypts data transmitted to or decrypting data received from a second electronic device based on the first private key over a wireless connection between the electronic device and the card device, wherein the wireless connection is established when the card device is detected as being in proximity to the electronic device.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to the size in actual implementation in order to clearly illustrate the concept of the present disclosure.

FIG. 1 is a schematic diagram of a system in accordance with an embodiment of the present disclosure.

FIG. 2 shows an alternative simplified functional block diagram of a wireless communication device according to one embodiment of the present disclosure.

FIG. 3A is a message flow for implementing a voice over Internet Protocol (VoIP) call between a first electronic device and a second electronic device according to an embodiment of the present disclosure.

FIG. 3B are a message flow illustrating that the second card device is detected as not being in proximity to the second electronic device according to an embodiment of the present disclosure.

FIG. 4 is a message flow for sharing a file between the first electronic device and the second electronic device according to an embodiment of the present disclosure.

FIG. 5 is a message flow for sharing a file between the first electronic device and the second electronic device via the server according to another embodiment of the present disclosure.

FIG. 6 is a message flow for authenticating the electronic device via the card device according to an embodiment of the present disclosure.

FIG. 7 is a message flow for implementing a voice over Internet Protocol (VoIP) call between a first electronic device and a second electronic device according to another embodiment of the present disclosure.

FIG. 8 is a message flow for sharing a file between the first electronic device and the second electronic device according to another embodiment of the present disclosure.

FIG. 9 is a flow chart illustrating a method for providing secure communication in accordance with an embodiment of the present disclosure.

### DETAILED DESCRIPTION OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Bluetooth wireless technology is set to revolutionize personal connectivity by providing freedom from wired connections. Bluetooth is a specification for a small form-factor, low-cost radio solution providing links between mobile computers, mobile phones and other portable and handheld devices. Of particular interest is Bluetooth's low power consumption and short range, coupled with the ability of Bluetooth devices to automatically detect and attach to other Bluetooth devices that are close by, typically within 10 meters or less.

Bluetooth wireless technology is an international, open standard for allowing intelligent devices to communicate with each other through wireless, short-range communications. This technology allows any sort of electronic equipment—from computers and cell phones to keyboards and headphones—to make its own connections, without wires, cables or any direct action from a user. Bluetooth is currently incorporated into numerous commercial products including laptops, PDAs, cell phones, and printers, with more products coming out every day.

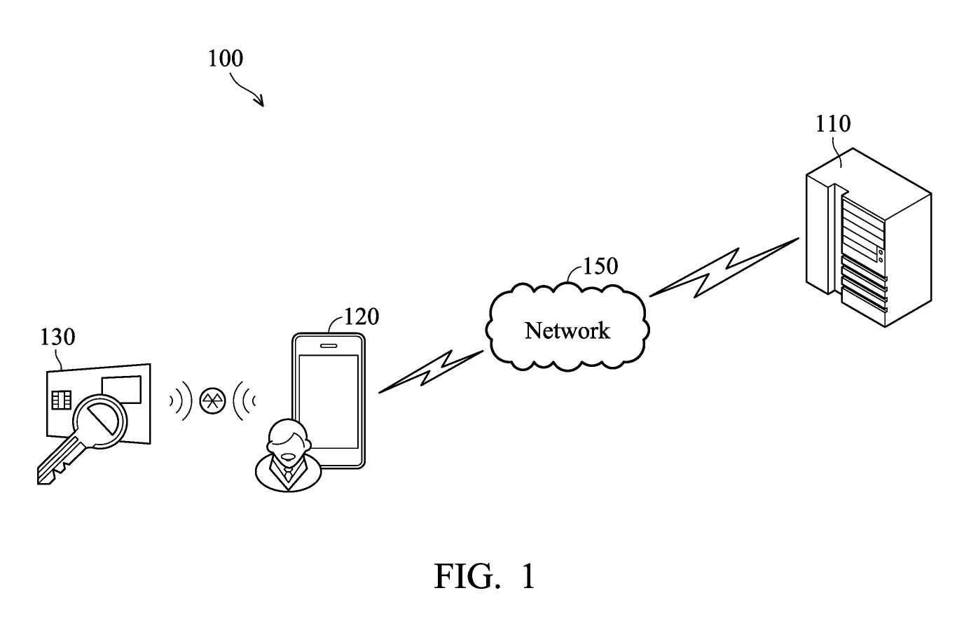

FIG. 1 is a schematic diagram of a system 100 in accordance with an embodiment of the present disclosure.

Referring to FIG. 1, the system 100 in accordance with a preferred embodiment of the present disclosure at least comprises a server 110, an electronic device 120, a card device 130 and a network 150. For the system 100, the electronic device 120 accesses the server 110 through the network 150 and they exchange necessary information with each other through the network 150.

The server 110 may employ a wired communications technology (such as LAN, Local Area Network, etc.) or a wireless communications technology (such as WLAN, etc.) to connect to the electronic device 120 for providing a service to users. The server 110 may be a desktop computer, a notebook computer, a cloud server or another electronic apparatus with a computation capability.

As described, the service might enable users to use services through their electronic devices. For example, the server 110 obtains information from the electronic device 120 and manages the obtained information. Furthermore, the server 110 may provide information (e.g., a website) to the electronic device 120. Such a service may be provided through dedicated applications or web-pages. In order to provide such service, the server 110 provides at least one of dedicated applications to the electronic device 120. That is, the electronic device 120 may download such dedicated applications and installs the downloaded application therein for accessing the service. However, the present disclosure is not limited thereto.

The electronic device 120 may be a device capable of communicating with other entities through the network 150. For example, the electronic device 120 may include a personal computer (PC), a smart phone, a laptop computer, a personal digital assistance (PDA), but the present disclosure is not limited thereto.

The card device 130 may be a wireless communication device which can be wirelessly connected to the electronic device 120 using short range radio communication technologies including Bluetooth short range connection technology. Specifically, the electronic device 120 can establish a wireless connection including a Bluetooth wireless connection with the card device 130 when the card device 130 is detected as being in proximity to the electronic device 120.

The server 110 may use public key Infrastructure (PKI) to perform the function of generating a key pair, wherein the key pair has a public key and a private key, and the private key corresponds to the public key. The public key is stored in the server 110 and the key pair is assigned to the card device 130 at manufacture or by a device manufacturer. It should be noted that each of the “device manufacturer,” or the “service provider,” may be referred to as a “key issuer” for providing the key pair. In addition, a user may visit the server 110 for registration via the electronic device 120. When the user's identity has already been authenticated by the server 110, the server 110 may use PKI to generate an account key pair of the electronic device 120, wherein the account key pair has an account public key and an account private key, and the account private key corresponds to the account public key. The account public key of the electronic device 120 is stored in the server 110 and the account key pair is assigned to the electronic device 120.

In addition, the card device 130 may also be implemented in the form of a smart card. In one embodiment, the size of the card device is 85.5 mm in length and 54 mm in width, which can easily fit into a wallet or a badge. The card device 130 may at least comprise a secure integrated circuit (IC) which stores the public key and the private key. In one embodiment, the card device 130 may have a near field communication (NFC) function for proximity sensing (e.g., door access control via the NFC function). In another embodiment, the card device 130 may further comprise a display which can take the form of electronic paper, also called e-paper or electronic ink display to display information of the card device 130 (e.g., a photo or access status of the user). In one embodiment, the card device 130 may comprise a rechargeable battery circuit for providing power to the card device 130.

Before the user using the electronic device 120 wants to use the card device 130 to increase secure communication, the user has to execute a process for binding the public key stored in the card device 130 and the account public key stored in the electronic device 120 to a user account. Specifically, the user may trigger a process called pairing with the card device 130 via the electronic device 120 so as to establish a Bluetooth connection. Then, the user registers the user account with the server 110. When the Bluetooth connection between the card device 130 and the electronic device 120 is established, the electronic device 120 and the card device 130 may exchange their public keys (e.g., the public key stored in the card device 130 and the account public key stored in the electronic device 120). Next, the electronic device 120 may update the public key of the card device 130 and the account public key of the electronic device 120 to the server 110. The server 110 binds the public key of the card device 130 and the account public key of the electronic device 120 to the user account after receiving the public key of the card device 130 and the account public key of the electronic device 120.

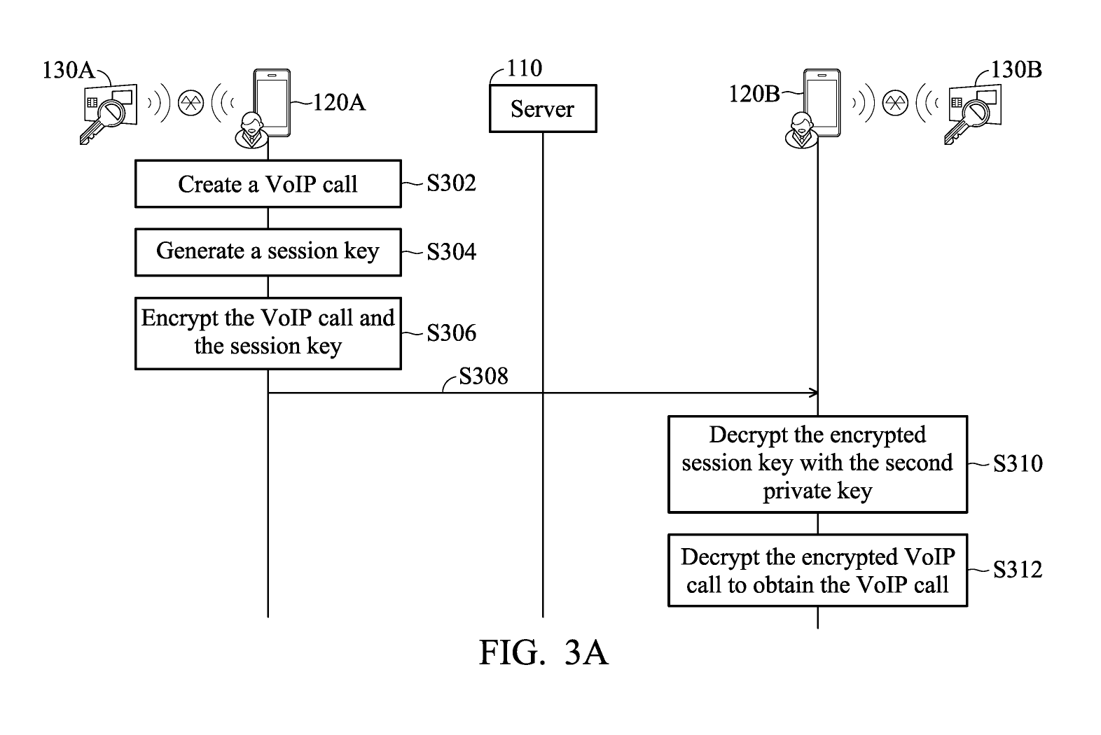

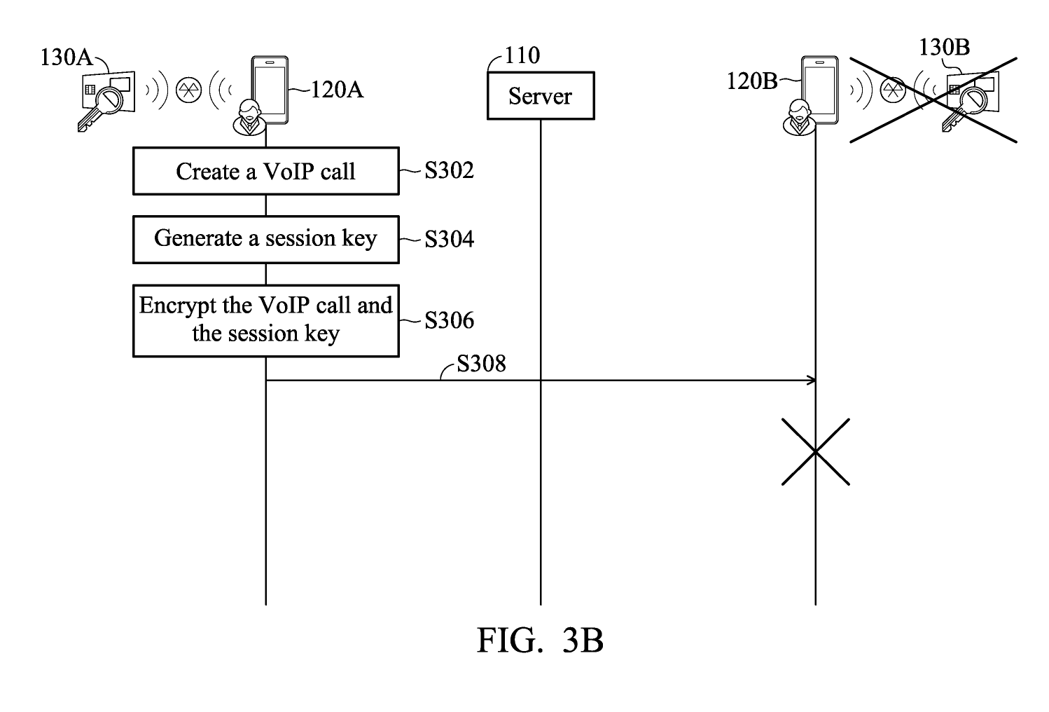

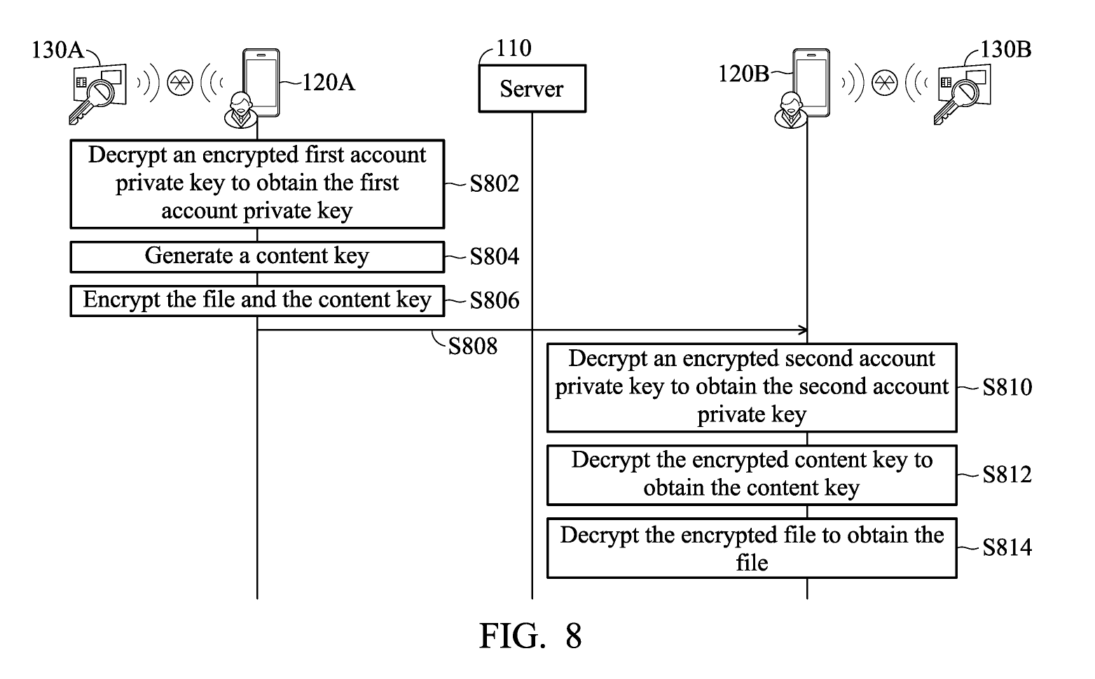

After the server 110 binds the public key of the card device 130 and the account public key of the electronic device 120 to the user account, the user may use the card device 130 to increase secure communication for data being transmitted from or received by the electronic device 120 across a wireless connection. The details of how the card device 130 provides the secure communication are shown in and described with reference to FIGS. 3 and 8.

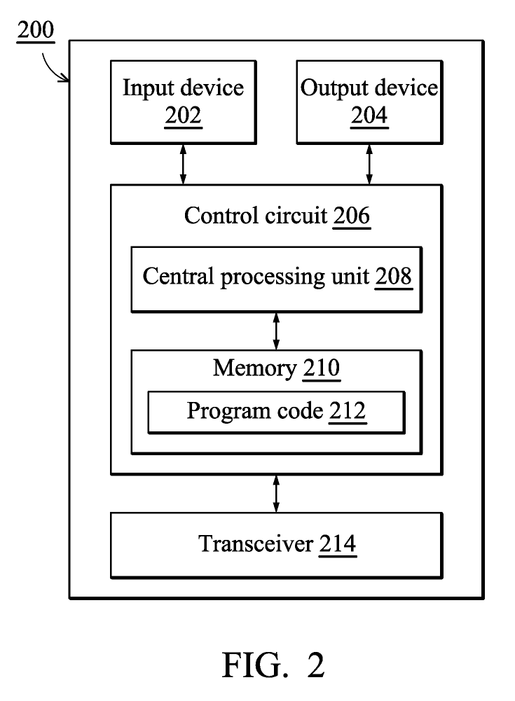

Next, turning to FIG. 2, FIG. 2 shows an alternative simplified functional block diagram of a wireless communication device 200 according to one embodiment of the present disclosure. As shown in FIG. 2, the wireless communication device 200 can be utilized for realizing the electronic device 120 and the server 110. The wireless communications device 200 may include an input device 202, an output device 204, a control circuit 206, a central processing unit (CPU) 208, a memory 210, a program code 212, and a transceiver 214. The control circuit 206 executes the program code 212 in the memory 210 through the CPU 208, thereby controlling the operation of the wireless communications device 200. The wireless communications device 200 can receive signals input by a user through the input device 202, such as a keyboard or keypad, and can output images and sound through the output device 204, such as a monitor or speakers. The transceiver 214 is used to receive and transmit wireless signals wirelessly, deliver received signals to the control circuit 206, and output signals generated by the control circuit 206.

FIG. 3A is a message flow for implementing a voice over Internet Protocol (VoIP) call between a first electronic device 120A and a second electronic device 120B according to an embodiment of the present disclosure, wherein the first electronic device 120A is a caller and the second electronic device 120B is a recipient. It should be noted that before the message flow, the first electronic device 120A and the second electronic device 120B may download the dedicated applications from the server 110 and install the downloaded application for corresponding to the first card device 130A and the second card device 130B, respectively. In addition, the first electronic device 120A and the second electronic device 120B may obtain the public keys associated with the first card device 130A and the second card device 130B from the server 110 in advance.

In step S302, the first electronic device 120A creates a VoIP call. In step S304, the first electronic device 120A generates a session key to be used for this VoIP call only by using the second public key associated with the second card device 130B and the first private key which is stored in the first card device 130A over the first wireless connection in accordance with an encryption algorithm, such as a public key infrastructure (PKI), wherein the first wireless connection is established when the first card device 130A is detected as being in proximity to the first electronic device 120A and the session key can be a symmetric encryption key, such as an advanced encryption standard (AES) key.

In step S306, the first electronic device 120A encrypts the VoIP call with the session key and encrypts the session key with the second public key associated with the second card device 130B. In step S308, the first electronic device 120A transmits data comprising the encrypted session key and the encrypted VoIP call to the second electronic device 120B. In one embodiment, the first electronic device 120A may transmit the data to the second electronic device 120B via the server 110.

When the second electronic device 120B receives the data comprising the encrypted VoIP and the encrypted session key from the first electronic device 120A, in step S310, the second electronic device 120B decrypts the encrypted session key with the second private key stored in the second card device 130B over a second wireless connection to obtain the session key, wherein the second wireless connection is established when the second card device 130B is detected as being in proximity to the second electronic device 120B. In step S312, the second electronic device 120B decrypts the encrypted VoIP call with the session key to obtain the VoIP call.

When the card device is detected as not being in proximity to the electronic device, the wireless connection between the electronic device and the card device does not exist so that the electronic device cannot encrypt data transmitted to or decrypt encrypted data received from other electronic device.

FIG. 3B are a message flow illustrating that the second card device 130B is detected as not being in proximity to the second electronic device 120B according to an embodiment of the present disclosure. The steps having the same name as described in FIG. 3A are the same as the steps in FIG. 3A, so details related to the steps in FIG. 3B will be omitted.

As shown in FIG. 3B, since the second card device 130B is not in proximity to the second electronic device 120B, the second electronic device 120B cannot decrypt the encrypted session key by using the second private key stored in the second card device 130B. In this case, the second electronic device 120B cannot obtain the VoIP call even though the second electronic device 120B receives the encrypted VoIP call. Therefore, the security for communication of sensitive data can be improved via the card device.

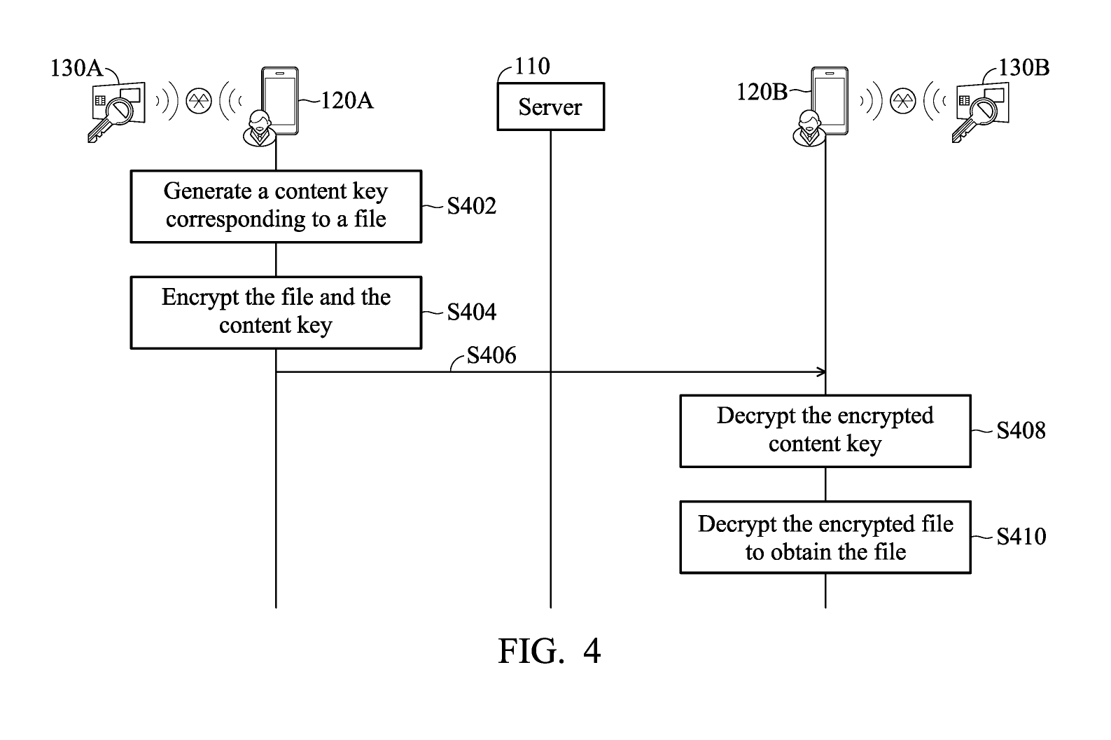

FIG. 4 is a message flow for sharing a file between the first electronic device 120A and the second electronic device 120B according to an embodiment of the present disclosure, wherein the first electronic device 120A is a sender and the second electronic device 120B is a receiver. It should be noted that before the message flow, the first electronic device 120A and the second electronic device 120B may download the dedicated applications from the server and install the downloaded application for corresponding to the first card device 130A and the second card device 130B, respectively. In addition, the first electronic device 120A and the second electronic device 120B may obtain the public keys associated with the first card device 130A and the second card device 130B from the server 110 in advance.

In step S402, the first electronic device 120A generates a content key corresponding to a file by using the second public key associated with the second card device 130B and the first private key which is stored in the first card device 130A over a first wireless connection, wherein the first wireless connection is established when the first card device 130A is detected as being in proximity to the first electronic device 120A, and the content key can be a symmetric encryption key used for this file only, such as an advanced encryption standard (AES) key. In step S404, the first electronic device 120A encrypts the file with the content key and encrypts the content key with the second public key associated with the second card device 130B. In step S406, the first electronic device 120A transmits data comprising the encrypted content key and the encrypted file to the second electronic device 120B.

When the second electronic device 120B receives the data comprising the encrypted file and the encrypted content key from the first electronic device 120A, in step S408, the second electronic device 120B decrypts the encrypted content key with the second private key stored in the second card device 130B over a second wireless connection to obtain the content key, wherein the second wireless connection is established when the second card device 130B is detected as being in proximity to the second electronic device 120B. In step S410, the second electronic device 120B decrypts the encrypted file with the content key to obtain the file.

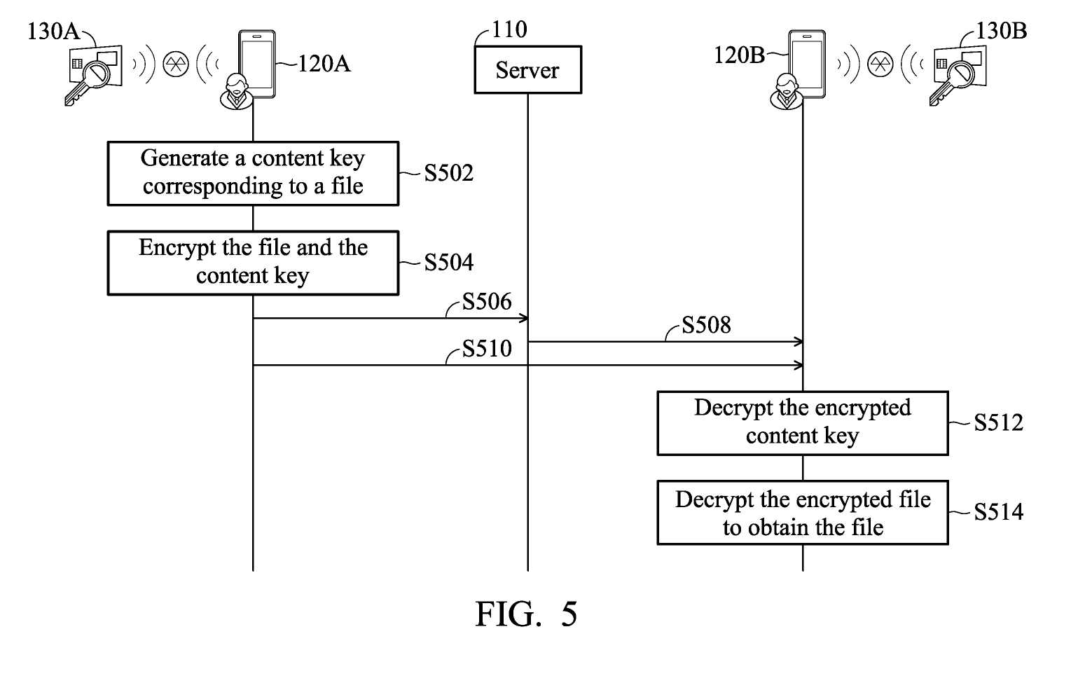

FIG. 5 is a message flow for sharing a file between the first electronic device 120A and the second electronic device 120B via the server 110 according to another embodiment of the present disclosure, wherein the first electronic device 120A is a sender and the second electronic device 120B is a receiver. It should be noted that before the message flow, the first electronic device 120A and the second electronic device 120B may download the dedicated applications from the server 110 and install the downloaded application for corresponding to the first card device 130A and the second card device 130B, respectively. In addition, the first electronic device 130A and the second electronic device 130B may obtain the public keys associated with the first card device 130A and the second card device 130B from the server 110 in advance.

In step S502, the first electronic device 120A generates a content key corresponding to a file by using the second public key associated with the second card device 130B and the first private key which is stored in the first card device 130A over a first wireless connection, wherein the first wireless connection is established when the first card device 130A is detected as being in proximity to the first electronic device 120A, and the content key can be a symmetric encryption key used for this file only, such as an advanced encryption standard (AES) key. In step S504, the first electronic device 120A encrypts the file with the content key and encrypts the content key with the second public key associated with the second card device 130B. In step S506, the first electronic device 120A transmits the encrypted file to the server 110 for storage.

Next, in step S508, the second electronic device 120B may download the encrypted file from the server 110. In step S510, the first electronic device 120A transmits the encrypted content key to the second electronic device 120B. In step S512, the second electronic device 120B decrypts the encrypted content key with the second private key stored in the second card device 130B over a second wireless connection to obtain the content key, wherein the second wireless connection is established when the second card device 130B is detected as being in proximity to the second electronic device 120B. In step S514, the second electronic device 120B decrypts the encrypted file with the content key to obtain the file.

As shown in FIG. 4, the first electronic device 120A may transmit the encrypted file and the encrypted content key corresponding to the file to the second electronic device 120B at the same time. In FIG. 5, the first electronic device 120A may also respectively transmit the encrypted file and the encrypted content key corresponding to the file to the server 110 and the second electronic device 120B.

When the card device is detected as not being in proximity to the electronic device, the wireless connection between the electronic device and the card device does not exist. In this case, the electronic device cannot encrypt data transmitted to or decrypt encrypted data received from other electronic device. For example, it is assumed that the second card device 130B is not in proximity to the second electronic device 120B. Since the second card device 130B is not in proximity to the second electronic device 120B, the second electronic device 120B cannot decrypt the encrypted data by using the second private key stored in the second card device 130B. Therefore, the second electronic device 120B cannot obtain the file even though the second electronic device 120B receives the encrypted data, so that the security for communication of sensitive data can be improved via the card device.

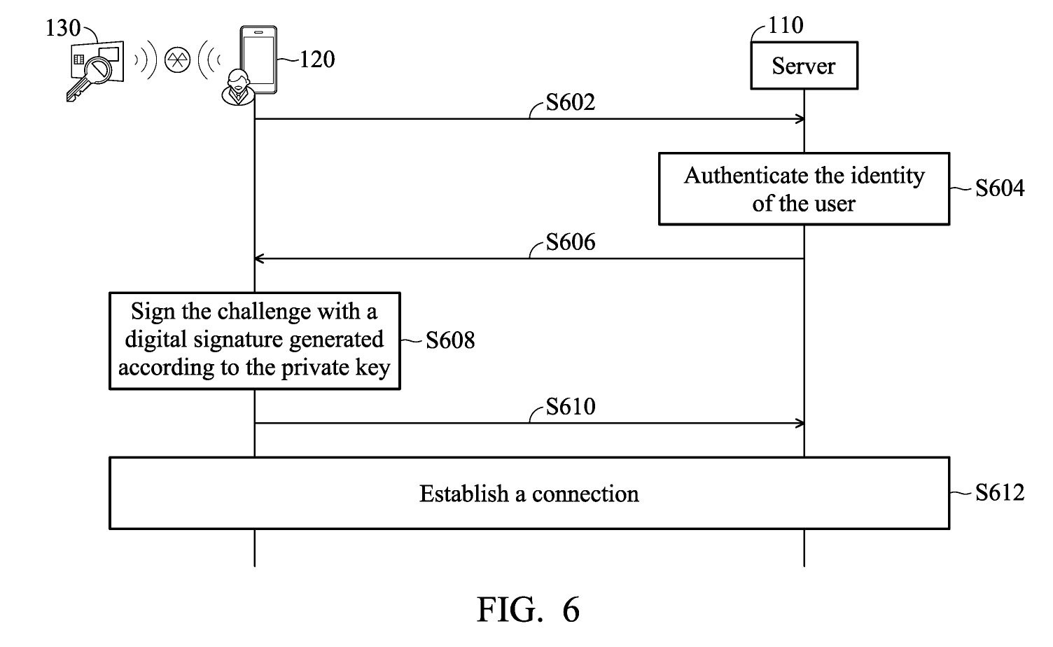

FIG. 6 is a message flow for authenticating the electronic device 120 via the card device 130 according to an embodiment of the present disclosure. It should be noted that before the message flow, the electronic device 120 may download the dedicated application from the server 110 and install the downloaded application for corresponding to the card device 130 storing the private key. In addition, the server 110 may store the public key corresponding to the private key.

In step S602, the electronic device 120 transmits a login request including one or more credentials of the user to the server 110 for requesting access to the service provided by the server 110. In step S604, the server 110 may use the credentials of the user to authenticate the identity of the user. When the user is authorized to access the service by the server, in step S606, the server 110 can transmit a challenge to the electronic device 120, wherein the challenge may include a timestamp or a random number generated according to the public key of the electronic device 120.

Next, when the electronic device 120 receives the challenge from the server 110, in step S608, the electronic device 120 signs the challenge with a digital signature generated according to the private key stored in the card device 130 over a wireless connection between the electronic device 120 and the card device 130, wherein the wireless connection is established when the card device 130 is detected as being in proximity to the electronic device 120. In step S610, the electronic device transmits the digital signature of the challenge to the server 110 for authentication. In step S612, the server 110 establishes a connection between the electronic device 120 and the server 110 to allow the electronic device to access the server 110 when the digital signature is verified.

When the card device 130 is detected as not being in proximity to the electronic device 120, the wireless connection between the electronic device 120 and the card device 130 does not exist. In this case, the electronic device 120 cannot sign the challenge with the digital signature generated by using the private key stored in the card device 130. Therefore, the security for authentication can be improved via the card device.

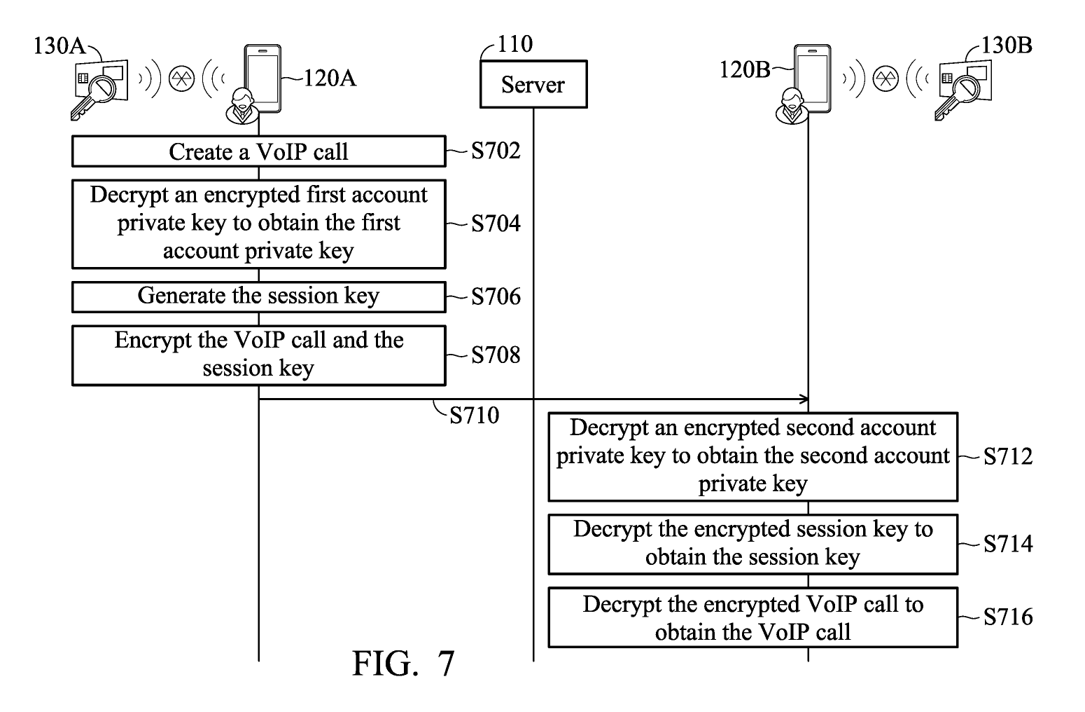

FIG. 7 is a message flow for implementing a voice over Internet Protocol (VoIP) call between a first electronic device 120A and a second electronic device 120B according to another embodiment of the present disclosure, wherein the first electronic device 120A is a caller and the second electronic device 120B is a recipient. It should be noted that before the message flow, the first electronic device 120A and the second electronic device 120B may download the dedicated applications from the server 110 and install the downloaded application for corresponding to the first card device 130A and the second card device 130B, respectively. In addition, the first electronic device 120A and the second electronic device 120B may generate their own account key pair including an account public key and an account private key, and may obtain each other's account public key from the server 110 in advance.

It should be noted that the account private key should be encrypted by using a private key stored in the card device in advance over the wireless connection between the electronic device and the card device to generate an encrypted account private key, wherein the encrypted account private key and the account public key are stored in the electronic device.

In step S702, the first electronic device 120A creates a VoIP call. In step S704, the first electronic device 120A decrypts an encrypted first account private key stored in the first electronic device 120A by using the first private key stored in the first card device 130A over the first wireless connection between the first electronic device 120A and the first card device 130A to obtain the first account private key, wherein the first wireless connection is established when the first card device 130A is detected as being in proximity to the first electronic device 120A. In the embodiment, the first account private key exists in the first electronic device 120A when the first wireless connection between the first electronic device 120A and the first card device 130A exist. In other words, the first account private key may be cleared from the first electronic device 120A when the first wireless connection between the first electronic device 120A and the first card device 130A does not exist.

In step S706, the first electronic device 120A generates the session key corresponding to the VoIP call by using a second account public key associated with the second electronic device 120B and the first account private key over the first wireless connection in accordance with an encryption algorithm, such as a public key infrastructure (PKI).

In step S708, the first electronic device 120A encrypts the VoIP call with the session key and encrypts the session key with the second account public key associated with the second electronic device 120B. In step S710, the first electronic device 120A transmits data comprising the encrypted session key and the encrypted VoIP call to the second electronic device 120B. In one embodiment, the first electronic device 120A may transmit the data to the second electronic device 120B via the server 110.

When the second electronic device 120B receives the data comprising the encrypted VoIP and the encrypted session key from the first electronic device 120A, in step S712, the second electronic device 120B decrypts an encrypted second account private key stored in the second electronic device 120B by using the second private key stored in the second card device 130B over the second wireless connection between the second electronic device 120B and the second card device 130B to obtain the second account private key.

Next, in step S714, the second electronic device 120B decrypts the encrypted session key with the second account private key to obtain the session key. In step S716, the second electronic device 120B decrypts the encrypted VoIP call with the session key to obtain the VoIP call.

When the card device is detected as not being in proximity to the electronic device, the wireless connection between the electronic device and the card device does not exist so that the account private key in the electronic device is cleared from the electronic device. In this case, the electronic device cannot obtain the account private key and the VoIP call even though the electronic device has the encrypted account private key and the encrypted VoIP call. Therefore, the security for communication of sensitive data can be improved via the card device.

FIG. 8 is a message flow for sharing a file between the first electronic device 120A and the second electronic device 120B according to another embodiment of the present disclosure, wherein the first electronic device 120A is a sender and the second electronic device 120B is a receiver. It should be noted that before the message flow, the first electronic device 120A and the second electronic device 120B may download the dedicated applications from the server and install the downloaded application for corresponding to the first card device 130A and the second card device 130B, respectively. In addition, the first electronic device 120A and the second electronic device 120B may generate their own account key pair including an account public key and an account private key, and may obtain each other's account public key from the server 110 in advance.

It should be noted that the account private key should be encrypted by using a private key stored in the card device in advance over the wireless connection between the electronic device and the card device to generate an encrypted account private key, wherein the encrypted account private key and the account public key are stored in the electronic device.

In step S802, the first electronic device 120A decrypts an encrypted first account private key stored in the first electronic device 120A by using the first private key stored in the first card device 130A over the first wireless connection between the first electronic device 120A and the first card device 130A to obtain the first account private key, wherein the first wireless connection is established when the first card device 130A is detected as being in proximity to the first electronic device 120A. In the embodiment, the first account private key exists in the first electronic device 120A when the first wireless connection between the first electronic device 120A and the first card device 130A exist. In other words, the first account private key may be cleared from the first electronic device 120A when the first wireless connection between the first electronic device 120A and the first card device 130A does not exist.

In step S804, the first electronic device 120A generates a content key corresponding to a file by using a second account public key associated with the second electronic device 120B and the first account private key over the first wireless connection in accordance with an encryption algorithm, such as a public key infrastructure (PKI).

In step S806, the first electronic device 120A encrypts the file with the session key and encrypts the content key with the second account public key associated with the second electronic device 120B. In step S808, the first electronic device 120A transmits data comprising the encrypted content key and the encrypted file to the second electronic device 120B. In one embodiment, the first electronic device 120A may transmit the data to the second electronic device 120B via the server 110.

When the second electronic device 120B receives the data comprising the encrypted file and the encrypted content key from the first electronic device 120A, in step S810, the second electronic device 120B decrypts an encrypted second account private key stored in the second electronic device 120B by using the second private key stored in the second card device 130B over the second wireless connection between the second electronic device 120B and the second card device 130B to obtain the second account private key.

Next, in step S812, the second electronic device 120B decrypts the encrypted content key with the second account private key to obtain the content key. In step S814, the second electronic device 120B decrypts the encrypted file with the content key to obtain the file.

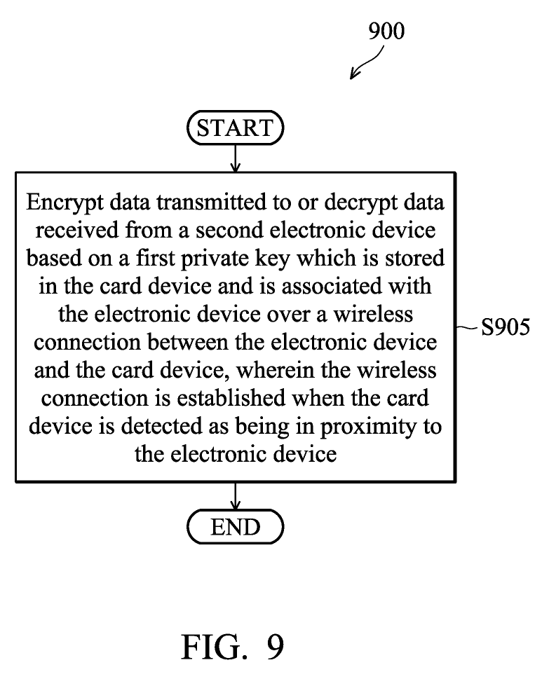

FIG. 9 is a flow chart 900 illustrating a method for providing secure communication in accordance with an embodiment of the present disclosure, wherein the method is used in a system at least comprising an electronic device and a card device.

In step S905, the electronic device encrypts data transmitted to or decrypts encrypted data received from a second electronic device based on a first private key which is stored in the card device and is associated with the electronic device over a wireless connection between the electronic device and the card device, wherein the wireless connection is established when the card device is detected as being in proximity to the electronic device.

In one embodiment, the data comprises communication data and a secret key corresponding to the communication data, wherein the communication data is a VoIP call and the secret key is a session key, or the communication data is a file and the secret key is a content key. The electronic device encrypting the communication data transmitted to the second electronic device based on the first private key stored in the card device associated with the electronic device in step S905 further generates the secret key corresponding to the communication data, encrypts the secret key by using a second public key associated with the second card device in asymmetric encryption or Diffie-Hellman type key exchange, encrypts the communication data by using the secret key and transmits the data comprising the encrypted secret key and the encrypted communication data to the second electronic device.

In one embodiment, the data comprises an encrypted communication data and an encrypted secret key corresponding to the communication data, wherein the encrypted communication data is an encrypted VoIP call and the encrypted secret key is an encrypted session key, or the encrypted communication data is an encrypted file and the encrypted secret key is an encrypted content key. The electronic device decrypting the data received from the second electronic device based on the first private key in step S905 further decrypts the encrypted secret key with the first private key over the wireless connection to obtain the secret key and decrypts the encrypted communication data with the secret key to obtain the communication data.

In one embodiment, before the electronic device encrypts the data transmitted to or decrypts the data received from the second electronic device, the electronic device further decrypts an encrypted first account private key stored in the electronic device by using the first private key stored in the card device over the wireless connection between the electronic device and the card device, wherein the encrypted first account private key is encrypted by using the first private key stored in the card device over the wireless connection. The data comprises communication data and a secret key corresponding to the communication data, wherein the communication data is a VoIP call and the secret key is a session key, or the communication data is a file and the secret key is a content key. The electronic device encrypting the communication data transmitted to the second electronic device based on the first account private key associated with the electronic device in step S905 further generates the secret key corresponding to the communication data, encrypts the communication data by using the secret key, encrypts the secret key by using a second account public key associated with the second electronic device in asymmetric encryption or Diffie-Hellman type key exchange and transmits the data comprising the encrypted secret key and the encrypted communication data to the second electronic device.

In one embodiment, before the electronic device encrypts the data transmitted to or decrypts the data received from the second electronic device, the electronic device further decrypts an encrypted first account private key stored in the electronic device by using the first private key stored in the card device over the wireless connection between the electronic device and the card device, wherein the encrypted first account private key is encrypted by using the first private key stored in the card device over the wireless connection. The data comprises an encrypted communication data and an encrypted secret key corresponding to the communication data, wherein the encrypted communication data is an encrypted VoIP call and the encrypted secret key is an encrypted session key, or the encrypted communication data is an encrypted file and the encrypted secret key is an encrypted content key. The electronic device decrypting the data received from the second electronic device based on the first account private key associated with the electronic device further decrypts the encrypted secret key with the first account private key to obtain the secret key and decrypts the encrypted communication data with the secret key to obtain the communication data.

In addition, the CPU 208 could execute the program code 212 to perform all of the above-described actions and steps or others described herein.

Therefore, according to the method and the system for providing secure communication provided in the present disclosure, the data can be encrypted or decrypted with the existence of the card device, so that the security of the data can further be increased.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In addition, in the above exemplary device, although the method has been described on the basis of the flow diagram using a series of the steps or blocks, the present invention is not limited to the sequence of the steps, and some of the steps may be performed in order different from that of the remaining steps or may be performed simultaneously with the remaining steps. For example, in FIG. 5, the electronic device 120A may first encrypts the content key with the second public key associated with the second card device 130B and then transmits the encrypted content key to the second electronic device 120B. Next, the second electronic device 120B downloads the encrypted file from the server 110. For another example, in FIG. 7 and FIG. 8, step S704, S712, S802, and S810 may occur at any moment as long as the card device is detected as being in proximity to the electronic device. Furthermore, those skilled in the art will understand that the steps shown in the flow diagram are not exclusive and they may include other steps or one or more steps of the flow diagram may be deleted without affecting the scope of the present invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of exemplary embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A method for providing secure communication, used in a system at least comprising an electronic device and a card device, comprising:
encrypting data transmitted to or decrypting data received from a second electronic device based on a first private key which is stored in the card device and is associated with the electronic device over a wireless connection between the electronic device and the card device;
wherein the wireless connection is established when the card device is detected as being in proximity to the electronic device.

2. The method for providing secure communication as claimed in claim 1, wherein the data comprises communication data and a secret key corresponding to the communication data, and the step of encrypting the communication data transmitted to the second electronic device based on the first private key stored in the card device associated with the electronic device further comprises:
generating the secret key corresponding to the communication data;
encrypting the secret key by using a second public key associated with the second card device;
encrypting the communication data by using the secret key; and
transmitting the data comprising the encrypted secret key and the encrypted communication data to the second electronic device.

3. The method for providing secure communication as claimed in claim 2, wherein the communication data is a voice over Internet Protocol (VoIP) call and the secret key is a session key; or the communication data is a file and the secret key is a content key.

4. The method for providing secure communication as claimed in claim 1, wherein the data comprises an encrypted communication data and an encrypted secret key corresponding to the communication data, and the step of decrypting the data received from the second electronic device based on the first private key stored in the card device associated with the electronic device further comprises:
decrypting the encrypted secret key with the first private key over the wireless connection to obtain the secret key; and
decrypting the encrypted communication data with the secret key to obtain the communication data.

5. The method for providing secure communication as claimed in claim 4, wherein the encrypted communication data is an encrypted voice over Internet Protocol (VoIP) call and the encrypted secret key is an encrypted session key; or the encrypted communication data is an encrypted file and the encrypted secret key is an encrypted content key.

6. The method for providing secure communication as claimed in claim 1, further comprising:
transmitting a login request to a server;
receiving a challenge from the server;
signing the challenge with a digital signature generated according to the first private key over the wireless connection;
transmitting the digital signature of the challenge to the server for authentication; and
establishing a connection between the electronic device and the server to allow the electronic device to access the server when the digital signature is verified.

7. The method for providing secure communication as claimed in claim 1, wherein the wireless connection is a Bluetooth wireless connection.

8. The method for providing secure communication as claimed in claim 1, wherein before encrypting the data transmitted to or decrypting the data received from the second electronic device, the method further comprises:
decrypting an encrypted first account private key stored in the electronic device by using the first private key stored in the card device over the wireless connection between the electronic device and the card device, wherein the encrypted first account private key is encrypted by using the first private key stored in the card device over the wireless connection.

9. The method for providing secure communication as claimed in claim 8, wherein the data comprises communication data and a secret key corresponding to the communication data, the step of encrypting the communication data transmitted to the second electronic device based on the first account private key associated with the electronic device further comprises:
generating the secret key corresponding to the communication data;
encrypting the communication data by using the secret key;
encrypting the secret key by using a second account public key associated with the second electronic device; and
transmitting the data comprising the encrypted secret key and the encrypted communication data to the second electronic device,
wherein the communication data is a voice over Internet Protocol (VoIP) call and the secret key is a session key; or the communication data is a file and the secret key is a content key.

10. The method for providing secure communication as claimed in claim 8, wherein the data comprises an encrypted communication data and an encrypted secret key corresponding to the communication data, and the step of decrypting the data received from the second electronic device based on the first account private key associated with the electronic device further comprises:
decrypting the encrypted secret key with the first account private key to obtain the secret key; and
decrypting the encrypted communication data with the secret key to obtain the communication data;
wherein the encrypted communication data is an encrypted voice over Internet Protocol (VoIP) call and the encrypted secret key is an encrypted session key; or the encrypted communication data is an encrypted file and the encrypted secret key is an encrypted content key.

11. A system for providing secure communication, at least comprising:
an electronic device; and
a card device, storing a first private key associated with the electronic device;
wherein the electronic device encrypts data transmitted to or decrypting data received from a second electronic device based on the first private key over a wireless connection between the electronic device and the card device;
wherein the wireless connection is established when the card device is detected as being in proximity to the electronic device.

12. The system for providing secure communication as claimed in claim 11, wherein the data comprises communication data and a secret key corresponding to the communication data, and the electronic device encrypting the communication data transmitted to the second electronic device based on the first private key further executes:
generating the secret key corresponding to the communication data;
encrypting the secret key by using a second public key associated with the second card device;
encrypting the communication data with the secret key; and
transmitting the data comprising the encrypted secret key and the encrypted communication data to the second electronic device.

13. The system for providing secure communication as claimed in claim 12, wherein the communication data is a voice over Internet Protocol (VoIP) call and the secret key is a session key; or the communication data is a file and the secret key is a content key.

14. The system for providing secure communication as claimed in claim 11, wherein the data comprises an encrypted communication data and an encrypted secret key corresponding to the communication data, and the electronic device decrypting the data received from the second electronic device based on the first private key further executes:
decrypting the encrypted secret key with the first private key over the wireless connection to obtain the secret key; and
decrypting the encrypted communication data with the secret key to obtain the communication data.

15. The system for providing secure communication as claimed in claim 14, wherein the encrypted communication data is an encrypted voice over Internet Protocol (VoIP) call and the encrypted secret key is an encrypted session key; or the encrypted communication data is an encrypted file and the encrypted secret key is an encrypted content key.

16. The system for providing secure communication as claimed in claim 11, wherein the system further comprises a server, and the electronic device further executes:
transmitting a login request to the server;
receiving a challenge from the server;
signing the challenge with a digital signature generated according to the first private key over the wireless connection;
transmitting the digital signature of the challenge to the server for authentication; and
establishing a connection between the electronic device and the server to allow the electronic device to access the server when the digital signature is verified.

17. The system for providing secure communication as claimed in claim 11, wherein the wireless connection is a Bluetooth wireless connection.

18. The system for providing secure communication as claimed in claim 11, wherein before the electronic device encrypts the data transmitted to or decrypts the data received from the second electronic device, the electronic device further executes:
decrypting an encrypted first account private key stored in the electronic device by using the first private key stored in the card device over the wireless connection between the electronic device and the card device, wherein the encrypted first account private key is encrypted by using the first private key stored in the card device over the wireless connection.

19. The system for providing secure communication as claimed in claim 18, wherein the data comprises communication data and a secret key corresponding to the communication data, the electronic device encrypting the communication data transmitted to the second electronic device based on the first account private key associated with the electronic device further comprises:
generating the secret key corresponding to the communication data;
encrypting the communication data by using the secret key;
encrypting the secret key by using a second account public key associated with the second electronic device; and
transmitting the data comprising the encrypted secret key and the encrypted communication data to the second electronic device,
wherein the communication data is a voice over Internet Protocol (VoIP) call and the secret key is a session key; or the communication data is a file and the secret key is a content key.

20. The system for providing secure communication as claimed in claim 18, wherein the data comprises an encrypted communication data and an encrypted secret key corresponding to the communication data, and the electronic device decrypting the data received from the second electronic device based on the first account private key associated with the electronic device further comprises:
decrypting the encrypted secret key with the first account private key to obtain the secret key; and
decrypting the encrypted communication data with the secret key to obtain the communication data;
wherein the encrypted communication data is an encrypted voice over Internet Protocol (VoIP) call and the encrypted secret key is an encrypted session key; or the encrypted communication data is an encrypted file and the encrypted secret key is an encrypted content key.
